(19) United States
(12) Patent Application Publication
(10) Pub. No.: US 2013/0238898 A1
(43) Pub. Date: Sep. 12, 2013

(54) Method for Providing Information for a Controller

(71) Applicants: Daniel Raichle, Vaihingen (DE); Stefan Blind, Fellbach (DE); Gary Morgan, Mains St Thixendale (GB); Nigel Tracey, York (GB); Nick Rolfe, York (GB); Paul Austin, Dunnington York (GB); Markus Gebhardt, Ingersheim (DE); Timon Reich, Schwieberdingen (DE); Alexander Steinert, Ludwigsburg (DE)

(72) Inventors: Daniel Raichle, Vaihingen (DE); Stefan Blind, Fellbach (DE); Gary Morgan, Mains St Thixendale (GB); Nigel Tracey, York (GB); Nick Rolfe, York (GB); Paul Austin, Dunnington York (GB); Markus Gebhardt, Ingersheim (DE); Timon Reich, Schwieberdingen (DE); Alexander Steinert, Ludwigsburg (DE)

(21) Appl. No.: 13/820,416

(22) PCT Filed: Jul. 27, 2011
(86) PCT No.: PCT/EP11/62906

§ 371 Date: May 30, 2013

(30) Foreign Application Priority Data
Sep. 1, 2010 (DE) 110 2010 040 115.

(51) Int. Cl. H04L 9/06

(52) U.S. Cl. CPC H04L 9/06
USPC 713/165

(57) ABSTRACT

A method for providing items of information that are provided for the operation of a control device for a motor vehicle and are stored in at least one original data file, in which at least one selected item of information from the at least one original data file is encrypted, and in which at least one selected item of information from the at least one original data file remains unencrypted, so that at least one partially encrypted data file is provided.

### FIELD OF THE INVENTION

The present invention relates to a method and to a system for providing information for a control device in a motor vehicle.

### BACKGROUND INFORMATION

In order to operate control devices for motor vehicles, control device software uses data files that include operating parameters. Such data files are for example in the A2L format, and are provided to a customer by a manufacturer of these data files for use in control devices as components of a motor vehicle.

In procedures as used up to now, a data file is standardly reduced by the quantities that are relevant for component protection or know-how protection. This reduced data file is provided to customers and to possible software sharing partners. The removal of critical quantities ensures both component protection and know-how protection. In the meantime, however, the use of so-called label databases by customers has made it necessary to provide data files, in particular A2L files, that contain all the quantities.

Standardly, the so-called zip format is used to compress data files. For cryptographic encryption, symmetrical cryptography methods can be used, such as AES (Advanced Encryption Standard). For the translation of binary data into the ASCII format, for example Base64, and thus a method for coding 8-bit binary data, can be used.

### SUMMARY OF THE INVENTION

Against this background, a method and a system are presented having the features of the independent patent claims. Further embodiments of the present invention result from the dependent patent claims and from the description.

The exemplary embodiments and/or exemplary methods of the present invention relate to the application of encryption functions for data files provided for the operation of control devices of technical devices, e.g. motor vehicles, as well as to a measure concerning how a partial encryption enabled by the encryption function is applied. Standardly, such data files are completely encrypted, which however would make such a data file completely unusable. In order nonetheless to obtain a usable data file, only individual entries, and thus only individual items of information, within these data are encrypted. A data file that is partially encrypted in this way, within which at least one item of information is encrypted and at least one item of information is unencrypted, can be used for the operation of a label database. Through the partial encryption that is carried out, label databases, or identifier databases, can be supported while nonetheless at the same time ensuring know-how protection and component protection.

The method is suitable, in an embodiment, for data files fashioned as A2L files. An A2L file is a data file that is standardized over the ASAM group and that contains extensive information concerning a particular control device software state. However, control device software for the execution of application systems, such as INCA, CANape, etc., requires this information. For each measurement quantity and adjustment quantity, the corresponding memory address in the microcontroller (μC) is stored as an item of information in the A2L file. Customers, which can be original equipment manufacturers (OEM), often require the supplying of a complete A2L file that contains all the existing quantities. Here, an A2L file can contain a large number of items of information worthy of protection, e.g. parameters, which, in the case of incorrect data input, could result in the destruction of the control device (ECU, electronic control unit). Using the exemplary embodiments and/or exemplary methods of the present invention, it is possible to protect such information and thus also to protect control devices and components that are monitored by these control devices.

The use of a partial A2L encryption is accordingly suitable for application tools for control devices, such as INCA of the company ETAS, CANape of the company Vector, or Diagra of the company RA Consulting.

A part of an A2L file for the definition of an adjustment quantity as an item of information can be constructed as follows:

/begin CHARACTERISTIC -> example for parameter
tLOCK_P.OSC_SVPWM_Dyc2PWM.OSC_SVPWM.OSC_Output
SignalsCalculation -> Functional description
“Lock Time (in μs)” -> description of the parameter
VALU E -> parameter value/characteristic/table
0x801C540E -> address in the control device software
STANDARD_VALUE_U8 -> data type
0.0
Ct_50ns_s -> physical conversion
0.5 -> minimum value to be set
10.0 -> maximum value to be set
/end CHARACTERISTIC

A part of an A2L file for the definition of a measurement quantity as an item of information can be constructed as follows:

/begin MEASUREMENT -> measurement quantity
CIF_B_rq_rscobd_diag -> name of the quantity
“The primary device manages the OBD error memory and the
environmental conditions (freeze frame). This signal contains
the status information of the primary device to the dependent
secondary device that the OBD error memory was just asked to
delete. The depen” -> functional description
UBYTE -> data type
ident -> physical conversion formula
1
100
0
1
BIT_MASK 0x1
ECU_ADDRESS 0xD0003920 -> address in the SG software
/end MEASUREMENT

In an embodiment of the present invention, via at least one list, as a rule a white list (positive list) or a blacklist (negative list), it is defined which measurement or adjustment quantities should be readable and which not, as items of information within the data files that are to be provided for the customer. On the basis of the at least one named list, a tool filters for information that is not released, e.g. measurement and adjustment quantities. The information that is contained in the A2L file and that is worthy of protection and is not to be released, i.e. the designations thereof, e.g. name, description, unit, formula name, etc., and thus standardly non-released quantities, are secured either via an encryption method or via a cryptographic hash function. Here, in an embodiment the designations of items of information that are to be encrypted are also encrypted. Non-released quantities are thus not readable for users, for example a customer of a supplier of the information. Names of the non-released quantities can remain the same over all software states. This provides a limitation relative to a simple numbering of the quantities in the software make or a software programming.

If securing is to take place via an encryption function, the non-released quantities are here encrypted using a standard and sufficiently secure encryption method, e.g. RSA, AES, DES, RC5, etc., and a password. The encrypted quantities and their designations can subsequently be identified as encrypted quantities e.g. using a uniform prefix, here “Crypt_”.

If an original name, and thus an original designation, of a quantity runs for example B_k115, then an encrypted name produced during the encryption, and thus an encrypted designation of the quantity, can run Crypt_WL57RJVYW44GZRM2AJXLK3YXM. The encrypted quantity and the encrypted designation can here be decrypted using the correct password. No list for the allocation of the original name to the encrypted name is required. Depending on the encryption and subsequent coding that is used, the names can have different lengths.

If a securing is provided via a hash function or a control value function, an unambiguous hash value is allocated to each unreleased quantity via a cryptographic hash function, e.g. MD5, SHA, etc., and is used as the name of the quantity. The hash values can subsequently also be identified as encrypted quantities with encrypted designations using a uniform prefix, and marked in this way, here: “Crypt_”. If the original name runs B_k115, an encrypted designation for example produced using the hash function, here the encrypted name, can run Crypt_c43437d52489a345133159fe48aacfaf. Here, all quantities have, as designations, for example the same name length, because the hash function produces a defined number of characters. A password is not absolutely necessary here; an allocation of the encrypted designations to encrypted quantities takes place as a rule via a list.

In the described embodiments, it results that in a data file present as an A2L file, all quantities are contained as items of information. Items of information not released for the customers are unreadable, so that the function of an item of information cannot be inferred. Know-how protection for sensitive information is completely ensured.

Assurance of component protection is improved inter alia by a changed designation of an item of information formed as a quantity, because the customer presumably will not modify quantities that are entirely uninformative, whereas in the case of explanatory names the temptation to make unauthorized changes to these will be significantly greater. Despite the partial encryption of data files carried out in the context of the exemplary embodiments and/or exemplary methods of the present invention, the customer is capable of carrying out measurements of quantities monitored by control devices even though these are not readable by the customer, because a control device provided for this purpose can carry out a decryption internal to the control device. In addition, it is possible to correspondingly adjust particular quantities without its being necessary to disclose further know-how to the customer for this purpose.

In a further embodiment, a function for decrypting the A2L file can be integrated in an application software, e.g. for an application system, for the control device. This application software is standardly also configured for the measurement, calibration, diagnosis, and/or storing of quantities. With the application software, a corresponding clear text name of an encrypted item of information is not displayed until after the inputting of a password required for this purpose. Thus, it is typically possible to use partially encrypted A2L files. The danger of an accidental divulging of an unencrypted A2L file is significantly reduced. Moreover, the integration of the decryption function in a corresponding measurement data viewer, or a display device for measurement data, is possible. Unreadable quantities measured by the customer can subsequently be made readable again during an evaluation, which enables a simplification of the measurement data evaluation.

Accordingly, at least a partial encryption of data files can be provided within the scope of the exemplary embodiments and/or exemplary methods of the present invention. This measure can include a partial encryption and thus also a modification of designations, i.e. of descriptions, variables, parameters, etc., of some items of information of an original data file.

Accordingly, as a rule parts, i.e. at least one item of information, of the A2L file are encrypted. This encryption can take place in such a way that the encrypted parts are not usable without decryption at the customer. Instead of this, a special tool is required that is capable of using the associated key to decrypt the encrypted parts of the A2L file and to use them.

Alternatively, the entries in the A2L file can be partially encrypted in such a way that they can be used directly even without prior decryption and without a special tool. Only the names and descriptions of the variables and parameters of encrypted items of information are modified by the encryption, in such a way that the customer cannot obtain therefrom any know-how concerning the underlying software.

A partial A2L encryption of information may for example be carried out because a customer requires, for the preparation of data, all labels or identifiers of the software. However, information that is security-relevant and worthy of protection is not supplied to the customer.

The system according to the present invention is configured in order to carry out all the steps of the presented method. Individual steps of this method can also be carried out by individual components of the system. In addition, functions of the system or functions of individual components of the system can be realized as steps of the method. Moreover, it is possible for steps of the method to be realized as functions of at least one component of the system or of the system as a whole.

Further advantages and embodiments of the present invention result from the description and the accompanying drawings.

Of course, the above-named features and the features explained below can be used not only in the combination indicated in each case, but also in other combinations or by themselves without departing from the scope of the exemplary embodiments and/or exemplary methods of the present invention.

### BRIEF DESCRIPTION OF THE DRAWINGS

FIG. 1 shows, in a first diagram, a first specific embodiment of the method according to the present invention.

FIG. 2 shows, in a schematic representation, a second diagram relating to the first specific embodiment of the method according to the present invention.

FIG. 3 shows, in a schematic representation, a diagram relating to a second specific embodiment of the method according to the present invention, as well as an example of a system according to the present invention.

### DETAILED DESCRIPTION

The present invention is shown schematically in the drawings on the basis of specific embodiments, and is described in detail below with reference to the drawings.

The Figures are described overall and as a contiguous whole; identical reference characters designate identical components.

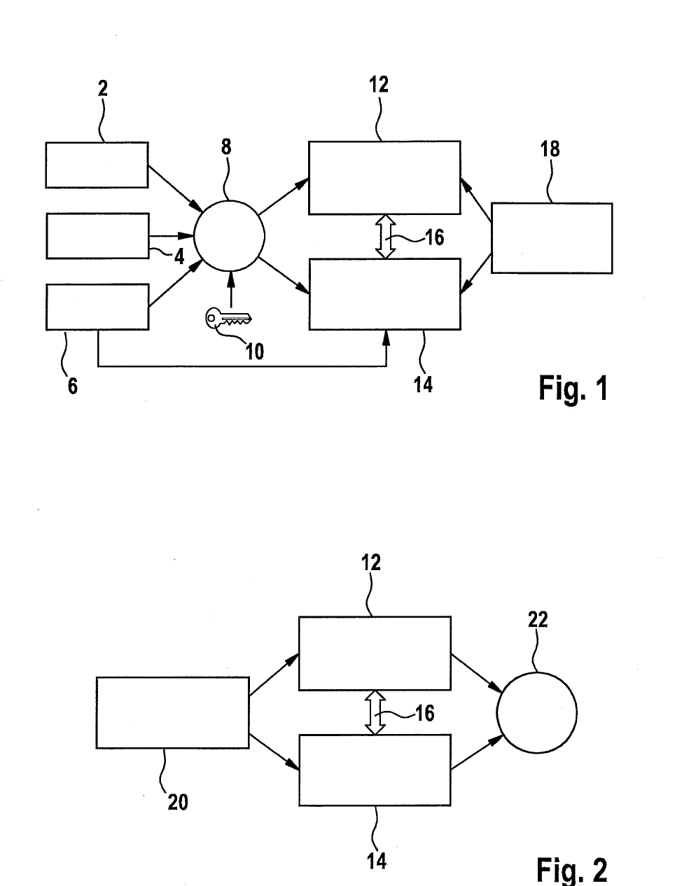

The first specific embodiment of the method according to the present invention is described on the basis of the two diagrams shown in FIGS. 1 and 2. In this specific embodiment of the method, a supplier and/or manufacturer of items of information for operating a control device provides these items of information to a customer and/or user of the control device within at least one data file 2, 4, 6, a part of the information in data files 2, 4, 6 being encrypted.

The first diagram shown in FIG. 1 indicates steps of the first specific embodiment of the method according to the present invention, executed at the supplier and/or manufacturer as sender. The second diagram in FIG. 2 shows steps of the first specific embodiment of the method according to the present invention executed at the customer and/or user as receiver.

The sender has three original data files 2, 4, 6 that contain items of information that are to be provided to the receiver. In addition, a first data file 2 includes private data, in this case items of information that represent intellectual property (IP) of the sender. A second data file 4 is fashioned as a public A2L file containing further items of information. A third data file 6 includes a memory image and may be present for example as a hex file or the like.

For the at least partial encryption of the information inside named data files 2, 4, 6, the sender encrypts at least the private information that is to be protected from first data file 2, using a first encrypting tool 8 in a computing unit (not shown), and using a key 10. In addition, this selected private information from first data file 2 is embedded into second data file 4, and thus into the A2L file, using key 10; in the present specific embodiment, a compression and an ASCII encryption are also carried out. In this step, a first partially encrypted data file 12 is provided having protected information and having a signature, this first partially encrypted data file 12 being fashioned as an A2L file.

Using a checksum algorithm, a signature of third data file 6, i.e. for the memory image, is provided, and as second partially encrypted data file 14 a hex file of the memory image is provided.

In the partial encryption that is carried out of the three original data files 2, 4, 6, the two partially encrypted data files 12, 14 that are produced are combined with one another and thus linked. In a further step, for example based on a specification that can be present in at least one list, it is derived which information of the second data file 14, present for example as a hex file, is relevant and is to be combined with the intellectual property that is to be protected from first partially encrypted data file 12. Alternatively, it is also possible to link the first partially encrypted data file with an unencrypted data file and/or with a completely encrypted data file.

The two data files 12, 14 combined via a linkage 16 are sent 18 to the receiver in such a way that conformity to the A2L standard is maintained.

At the receiver (diagram in FIG. 2) there takes place a reception 20 of the signed and partially encrypted data files 12, 14 that are in addition linked 16 to one another. For the receiver, it is possible to read the first partially encrypted data file 12 using a text editor. However, here the encrypted and thus protected items of information are not visible. An attempt at revising or editing the signature would damage this data file 12.

However, in an embodiment of the present invention it is provided that the receiver calls an executing decrypting tool 22 that includes a key and is for example provided by the sender, so that this decrypting tool 22 is executed on a control device (not shown). Using this decrypting tool 22, it is possible to make use of partially encrypted data files 12, 14. This decrypting tool 22 provides the correct key required for the decryption of the protected parts (IP) of first data file 12, and checks the signature. If a checking of the signature is not possible, this is an indication that a manipulation was carried out of first partially encrypted data file 12. In this case, a further execution of the information inside the data file by decrypting tool 22 can be terminated. If, however, a checking of the signatures is possible, a decryption of the encrypted information can be carried out, so that this now-decrypted information is provided as additional information by decrypting tool 22 in order to provide the receiver with expanded information.

With the described first specific embodiment of the method, it is possible for the sender involved in the method as well as the receiver, who can be an original equipment manufacturer (OEM), to exchange data files 12, 14. Here, the information is present for example as A2L files and as a memory image in the hex format, such A2L files partially including intellectual property of the sender that is not to be made accessible to the receiver. However, the encrypted information can be used by the receiver only with decrypting tool 22.

Thus, as information the sender provides the receiver with software that can be examined and checked by decrypting tool 22. Here, behavior of the software can be better represented to the receiver if internal items of information of the software are known. Using second partially encrypted data file 14, it is possible to disclose only particular selected items of information, but to encrypt particular items of information as intellectual property (IP) and to protect them.

However, using decrypting tool 22 it is also possible to decrypt protected parts of data file 12 and to use information contained therein for the operation of the control device, which includes decrypting tool 22. In the present specific embodiment, partially encrypted data files 12, 14 are additionally signed with the signature, and this signature can be based on a content of named data files 12, 14. This signature is certified by tools 8, 22. In this way, inter alia an unauthorized mixing of partially encrypted data files 12, 14, and their unauthorized modification, can be prevented.

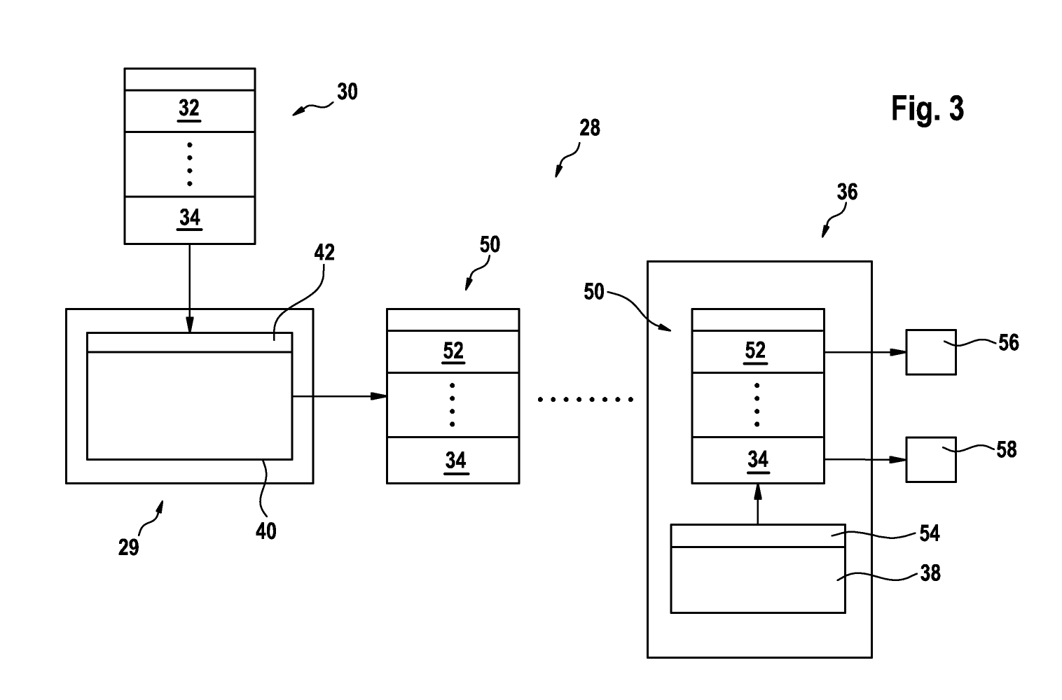

The second specific embodiment of the method according to the present invention is illustrated by the diagram shown in FIG. 3. FIG. 3 shows a specific embodiment of a system 28 according to the present invention having a computing unit 29 with which an encrypting tool 40 is executed as software. Moreover, FIG. 3 shows an original data file 30 that contains, as data, a plurality of original items of information 32, 34. During operation of a control device 36 as a further component of system 28, using this control device 36 software 38 is executed in which items of information 32, 34 of such a data file 30 are used.

In this specific embodiment of the method according to the present invention, at least one selected item of information, here a first item of information 32, is encrypted using encrypting tool 40, which has a key and is executed on computing unit 28. In contrast, at least one selected item of information, here a second item of information 34, within data file 30 is not encrypted. Which at least one item of information 32 is to be encrypted and which at least one item of information 34 is to be left unencrypted is specified by at least one list 42.

Thus, after the partial encryption has been carried out from original data file 30, after processing by encrypting tool 40 a partially encrypted data file 50 is provided. Inside this partially encrypted data file 50, a first encrypted item of information 52 emerges from first item of information 32 of original data file 30 after the partial encryption has been carried out. In addition, partially encrypted data file 50 also contains unencrypted second item of information 34 from original data file 30.

However, in a further step of the method according to the present invention, this partially encrypted data file 50 can nonetheless be executed by control device 36. For this purpose, control device 36 contains a decrypting tool 54 as a software component of software 38. Using a key, this decrypting tool 54 can decrypt encrypted first item of information 52 internally to the control device, so that with control device 36 a first function 56, based on first encrypted item of information 30, can be executed. A second function 58 of control device 36 is executed taking into account second, unencrypted item of information 34. These named functions 56, 58 are standardly suitable for monitoring and thus for controlling and/or regulating at least one component of a motor vehicle in which control device 36 is situated.

Given a production of first encrypted item of information 52 from first item of information 32 that is to be encrypted, in the described specific embodiment of the present invention a designation of this first item of information 32 is also encrypted and thus given a new character sequence that is not readable for a customer. Thus, an encrypted designation of first encrypted item of information 52, which emerged from original first item of information 32 after the encryption was carried out, does not provide any information concerning encrypted or original item of information 32, 50. Thus, the new encrypted designation of the now first encrypted item of information 52 can have an added part, for example a prefix, and thus can have a suitable marking that is added to the designation during the encryption of the designation, and that marks first encrypted item of information 52 as such. If a decryption of partially encrypted data file 50 is carried out, the encrypted designation of first encrypted item of information 52 is also decrypted. Here, the original first item of information 32 with its original designation again emerges from first encrypted item of information 52.

1-10. (canceled)

11. A method for providing items of information that are provided for operation of a control device for a motor vehicle and that are stored in at least one original data file, the method comprising:
encrypting at least one selected item of information from the at least one original data file, wherein at least one selected item of information from the at least one original data file remains unencrypted; and
providing at least one partially encrypted data file that has at least one encrypted item of information and at least one unencrypted item of information.

12. The method of claim 11, in which the at least one item of information that is to be encrypted is selected via at least one list.

13. The method of claim 11, in which a designation of the at least one item of information that is to be encrypted is encrypted.

14. The method of claim 11, in which the at least one at least partially encrypted data file is provided with a signature.

15. The method of claim 11, in which the at least one encrypted item of information is embedded into the at least one at least partially encrypted data file.

16. The method of claim 11, in which the at least one partially encrypted data file is linked with at least one additional data file.

17. The method of claim 16, in which the at least one additional data file is likewise partially encrypted.

18. A system for providing items of information that are provided for operation of a control device for a motor vehicle and that are stored in at least one original data file, comprising:
a computing unit having an encrypting tool to encrypt at least one selected item of information from the at least one original data file, and which leaves at least one selected item of information from the at least one original data file unencrypted, so as to provide at least one partially encrypted data file.

19. The system of claim 18, further comprising:
a decrypting tool to decrypt the at least one encrypted item of information from the at least one at least partially encrypted data file.

20. The system of claim 19, wherein the decrypting tool is executed using the control device.
